(19) United States
(12) Patent Application Publication
(10) Pub. No.: US 2024/0104404 A1
(43) Pub. Date: Mar. 28, 2024

(54) Methods, systems, non-transitory computer readable medium, and machine for maintaining emotion data in a computing environment

(71) Applicant: William Henry Starrett, JR., Richardson, TX (US)

(72) Inventor: William Henry Starrett, JR., Richardson, TX (US)

(73) Assignee: William Henry Starrett, JR., Richardson, TX (US)

(21) Appl. No.: 18/528,540

(22) Filed: Dec. 4, 2023

Related U.S. Application Data
(63) Continuation of application No. 14/921,682, filed on Oct. 23, 2015.
(60) Provisional application No. 62/068,463, filed on Oct. 24, 2014.

(51) Int. Cl. G06N 5/022; G06N 3/004

(52) U.S. Cl. CPC G06N 5/022; G06N 3/004

(57) ABSTRACT

This document discloses methods, systems, computer readable medium, and a machine for describing, mapping, modeling, generating, recreating, maintaining, archiving, and incorporating emotion or the immersive first-person experiences of self-awareness as data in a computing environment. In a preferable embodiment of the present invention, the method includes analyzing a body, obtaining information regarding at least some of the one or more relationships corresponding to location, topological, directional, distance, or temporal references, and generating a representation of the experience. In a preferable embodiment of the present invention, one or more methods also include the representation of immersive first-person experiences of emotion with other systems and data, the step of using comprising at least one of editing, generating, storing, converting, encoding, transmitting, displaying, editing, and incorporating data from input, output, outcome, result, or derivative values with applications, systems, or instance relevant computing environments.

### CROSS-REFERENCE TO RELATED APPLICATIONS

This application is a continuation of

Nonprovisional application Ser. No. 14/921,682, filed 2015 Oct. 23
which claims the benefit of or is a continuation of Provisional Application No. 62/068,463 filed 2014 Oct. 24.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### STATEMENT REGARDING PRIOR DISCLOSURES BY THE INVENTOR OR A JOINT INVENTOR

This application is a continuation of Nonprovisional application Ser. No. 14/921,682, filed 2015 Oct. 23. Prior disclosures include Provisional Application No. 62/068,463 filed 2014 Oct. 24.

### BACKGROUND OF THE INVENTION

### Technical Field

The present invention relates to the field of computing. More particularly, the present invention relates to methods, systems, non-transitory computer readable medium, and machine for editing, storing, converting, encoding, generating, or maintaining representations of experiences, physiological responses, or expressive responses as data in a computing environment.

### Background Art

Using a system with a memory, non-transitory computer readable medium, or machine with a memory, current techniques related to representing emotion data fall short because most references to emotion are limited to facial expressions and not intuition or the moving sensations throughout the body that create feedback inside of a human's subjective experience. Further, existing techniques rely primarily on reading human emotions from visual, electronic, or other types of current era external input devices for data entry. From these weaknesses, existing techniques related to emotion data are inherently limited to rudimentary emotional symbolism for only a portion of what one biological species, human beings, are consciously aware of and have labels for in their experience.

Describing nuanced and complex emotional experiences as a data representation has traditionally been purposed exclusively toward homogenizing a human user's interactive experience with technology. Current methods of representing known emotional experiences are deficient with accommodating enough information for recreating a viable human state experience biologically or in a virtual environment.

Programmatically, software applications tend to focus on solving a problem with types of rule-based decision making. Present technology's ineffective mapping of emotional state from sensation experience has limited computing environments from adequately recreating human state experiences or having the ability to freely model more complex sensation instances inside of emotional events, virtually. Because of the current business and technological questions in the divide between existing techniques and approaches toward adequately modeling how emotion can affect machine learning and problem solving strategies, the measured risks and benefits of including subjective state components like anger, stress, and fear or happiness and love in computing environment decision and learning models go unknown to science, business, and industry.

Consciousness, as a metaphor in a computing environment, resides beyond a wall where humans suspend awareness of how physical sensations, another result of processing experiential information against self-concept and belief constructs, create and extend the inwardness of subjective awareness. Without effective mapping and methodology for editing, storing, converting, encoding, generating, or maintaining nuanced representations of known and ambient emotion sensations, computing environments are left to associate to the unique symbolic ideas of understood emotions instead of how humans physically experience empathy, intuition, or emotion and subjectively relate to the abstractions of self-awareness as a range of complimentary, sometimes conflicting, processes.

### BRIEF SUMMARY OF THE INVENTION

An object of the present invention is to provide methods, systems, computer readable medium, and machine for editing, storing, converting, encoding, generating, or maintaining representations of subjective experiences, physiological responses, or expressive responses as a representation of emotion in a computing environment.

Aspects of the present invention may include one or more of the following: Methods, systems, computer readable medium, and machines for describing, modeling, recreating, maintaining, or incorporating first person subjectivity or emotion state component values in a computing environment. Methods, systems, computer readable medium, and machine for editing, storing, converting, encoding, generating, maintaining, or incorporating representations of emotion experiences as a data representation of events with component instances in a computing environment's virtually defined sensory or illusory space(s). Methods, systems, computer readable medium, and machine for editing, storing, converting, encoding, generating, or maintaining representations of self-concept, preconception, and belief construct component values in a computing environment. Methods, systems, computer readable medium, and machine for editing, storing, converting, encoding, generating, or maintaining data structures representing static or kinetic immersive first-person components of zero, one, or more of the following: intuition, empathy, anger, joy, euphoria, excitement, happiness, sadness, fear, love, mood, pain, nausea, headache, melancholy, depression, anxiety, grief, dysthymia, bipolar disorder, mania, psychosis, intoxication, and hallucination.

An advantage born from including data storage, processing, calculation, or decision models from instance relevant computing environments with representations of independent emotions or with the transitions that shape experiences is how one embodiment of the present invention could select from an array of case appropriate, possible, or probable choice responses and their property counterparts to maintain a modeled disposition or personality that may or may not be subject to state change or conditioning influenced from available input and output.

Advantages may also include one or more of the following: The act of defining a perspective or point of sensory origin allows for a model of it, its purpose, or its state attributes. As a scalable and extensible model for virtually depicting immersive first-person emotion sensations with a sensory origin, emotion states could be algorithmically generated toward massively complex mappings that include a theoretically unlimited number of members. Representing models can be created and studied to observe how emotions like stress and fear transition and affect a range of scenarios for decision making. Representing models can be created and studied to observe how emotions and transitions can be precipitated, affect behavior, and add benefit or risk to various types of problem solving and machine learning strategies. A representing model of an Emotion Experience or its components can be archived for scheduled or dynamic recollection and sharing between computing environments. A representing model of an Emotion Experience can promote the sensations and transitions of first person identity or empathy in computing environments. Representing models can explore and manage the benefits and risks of identity or emotion to decision making or learning strategies while interacting with humans or with data storage, calculation, processing, or decision models from application, system, or instance relevant computing environments. A representing model of Emotion Experience supporting input or output could provide a virtual experience of pulse, heartbeat, muscle ache, breeze against skin, the warmth of the sun on a subject representation's virtual face and arms, or nuanced tactile and immersive first-person physical sensation to application, system, or instance relevant computing environments. A representing model of an emotion experience with supporting models for personality or disposition could promote greater rapport or provide entertainment when interacting with adults, children, or pets.

In preferable embodiments, a computer readable medium (such as, for example, random access memory or a computer disk), a system with a memory, or a machine with a memory, comprises data, code, or both for carrying out the methods and maintaining representations as described herein.

### BRIEF DESCRIPTION OF DRAWINGS

A full disclosure including best mode and other features, aspects, and advantages of the present invention, as directed to one of ordinary skill in the art as set forth in the specification, makes reference to the accompanying drawings, wherein:

FIG. 1 is a third person depiction of a hierarchy of coordinate systems representing immersive first-person experiences of emotion as characterized in this example as a generic Emotion Sensation Matrix with virtual Defined Sensory Space. The Emotion Experience and component sensations may or may not feel in relation to a representation of vantage as characterized in this example as a Center of Consciousness or attention—a representation of where center of one's thoughts or feelings originate—in a preferable embodiment of the present invention;

FIG. 2 is a third person depiction representing one or more member of a hierarchy of coordinate systems as characterized in this example as a virtual Defined Sensory Space in the shape of a human head for what could be modeled in a preferable embodiment of the present invention;

FIG. 3 is a flow chart example for defining a representation of an immersive first-person experience of emotion characterized in this example as one or more Emotion Sensation Instance(s), one or more Emotion Sensation Event(s), and one or more Emotion Sensation Experience(s) for modeling in a preferable embodiment of the present invention;

FIG. 4 illustrates an example for how representations of immersive first-person emotion experiences, in this example characterized as Emotion Experience components, relate to each other in a preferable embodiment of the present invention;

FIG. 5 is a schematic illustration of an example system architecture for incorporating representations of immersive first-person emotion experiences, in this example characterized as Emotion Experience, and component data with other data, calculation, or processing from application, system, or instance relevant computing environments in a preferable embodiment of the present invention;

FIG. 6 is a schematic illustration of an example system architecture for incorporating representations of personality and disposition components with Emotion Experience processing in a preferable embodiment of the present invention;

FIG. 7 is a flow chart example of how incoming data can be filtered by representations of Preconception, Belief, and Construct items in one embodiment of the present invention;

FIG. 8 is a system diagram illustrating a representation model authoring environment and an exemplary display, output processing, or runtime environment according to preferable embodiments;

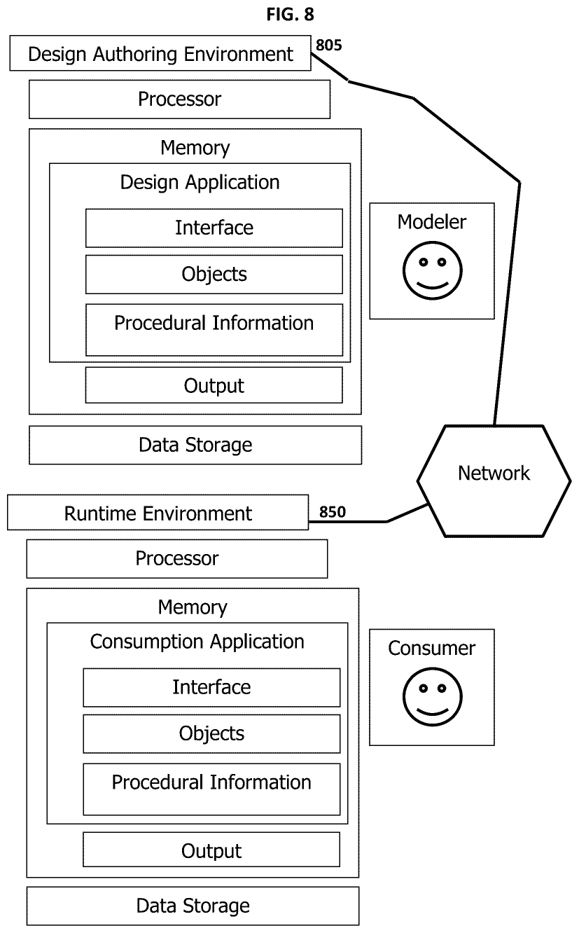

FIG. 9 is a pictorial diagram depicting a machine, in this example embodiment, a general purpose computer system capable of supporting a high resolution graphics display device and a cursor pointing device, such as a mouse, on which one preferable embodiment of the present invention may be implemented; and

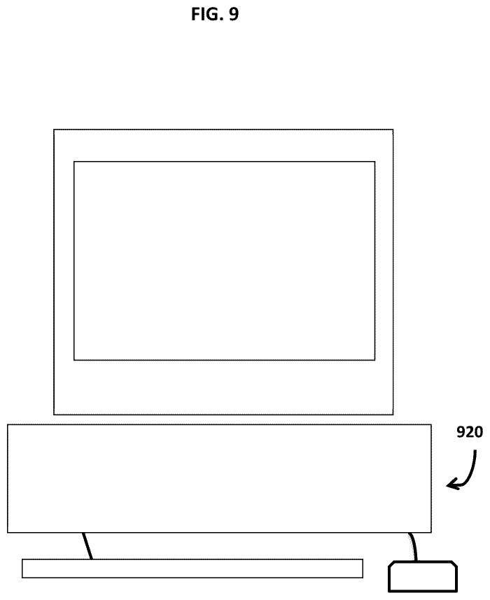

FIG. 10 is a diagram illustrating a non-transitory computer readable medium containing data representing either of, or both of, data structures or program instructions in a preferable embodiment.

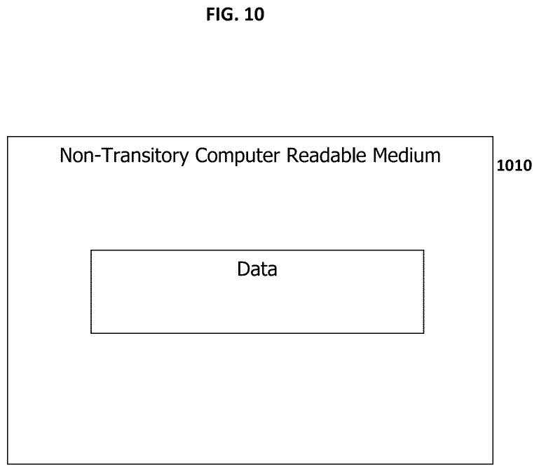

### DETAILED DESCRIPTION OF THE INVENTION

Many models orient from an observer's point of study toward a subject. An important distinction of a nuanced or complex emotional experience is how contained they remain internally in the observed from beginning to between transitions or regardless of any outward acts they may inspire.

In preferable embodiments, a non-transitory computer readable medium 1010, a system with a memory 805 850 or a machine with a memory 920, comprises either data structures, program instructions, or both for carrying out the methods and maintaining representations as described herein.

Because a component to a preferable embodiment of the present invention defines a representation of an immersive subjective experience first person, ideally, the present invention could first orient from the subject's own sense of self outward through defined sensory spaces representing physical structures and distantly further into the illusory.

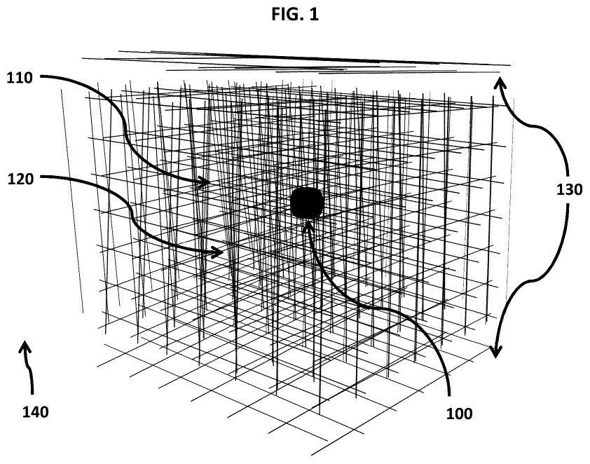

FIG. 1 is a third person depiction of a hierarchy of coordinate systems representing immersive first-person experiences of emotion as characterized in this example as a generic Emotion Sensation Matrix with virtual Defined Sensory Space 210. The representation of Emotion Experience and component sensations may or may not feel in relation to Center of Consciousness 100 or attention—where center of one's thoughts or feelings originate—in a preferable embodiment of the present invention.

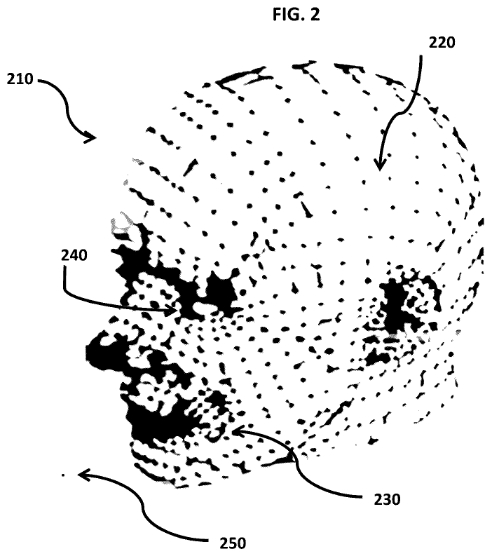

FIG. 2 is a third person depiction representing one or more member of a hierarchy of coordinate systems characterized in this example as a virtual Defined Sensory Space in the shape of a human head in a preferable embodiment of the present invention.

For humans, Center of Consciousness 100 or attention can originate from the center of one's thoughts or feelings. If aware of it at all, for hearing or visually dominant individuals, their perception may feel seated near the center of their head or forward into their line of vision. For people with closed eyes, vision impairment, kinesthetic dominant or emotive individuals, the idea of themselves may occasionally or consistently reside lower down toward the neck or into their body's torso from the throat, heart, or gut.

In modeling a recollection of the past, vision for the future, an altered state experience, psychological event, or abnormality, it is possible that sense of self may feel fully disassociated from the defined sensory spaces and, instead, seem outside or distantly located away into the Illusory 140. A preferable embodiment of the present invention would allow for stylistic representations of the emotion component sensations, defined and Illusory 140, and accommodate authentically for representing an entire static or dynamic experience as a biological model would with its virtually located representations of physical structures as what could be preferably characterized as a Defined Sensory Space 210 acting as a bridge to perception.

Neuro-Linguistic Programming, an approach to communication, personal development, and psychotherapy, was created by Richard Bandler and John Grinder in California, United States in the 1970s.

Bandler teaches how, as humans, when we experience an emotion or feeling, the sensations of that event can typically be located in a specific area of the body.

From this study of Neuro-Linguistic Programming, an individual's body has been described as not separate from the brain but an extended part of the brain.

As one example of a therapeutic case study, when an individual reports that they are frustrated, important questions to ask the subject may begin with, “Where? Where does the feeling start? Where do you feel it first in your body? Where does it move to?”

As observable in a moment of introspection, feelings are mobile and cannot remain static because they are always moving somewhere and in some direction.

Furthermore, with how the sensations of emotion seemingly move, you can use your imagination to move them faster. You can imagine slowing the emotion sensations down. You can also move the emotion sensations forward or backward. From this ability to identify our feelings and imagine them toward change, these immersive first-person sensations of emotion are not outside of our control. In fact, with influencing our experience of emotion one can mindfully identify and select their feelings.

One can identify and leverage the sensations of feeling and emotion by first recognizing where in a subject's body the feeling starts and where it goes to. Discover the direction it spins inside the subject's body and have them imagine the sensation spinning faster and faster for feelings to intensify. From this, we can gain greater control over our brains to both create powerful feelings inside us and model representations of the experience of emotion in a hierarchy of coordinate systems.

In a preferable embodiment of the present invention, representations of first-person immersive Emotion Experiences and the component sensations that may define them could be at least characterized as Known 120 or the sensations, feelings, and experiences that a subject is aware of; Understood 110 or the sensations, feelings, and experiences that a subject can identify and possibly understand as experiencing; and Ambient 130 or the sensations, feelings, and experiences that weave together and fill in remaining space of the subjective self's fabric of reality.

Preferably, Known 120, Understood 110, Ambient 130 or other sensations, feelings, and experiences may or may not relate to symbols or commonly accepted labels used by the subject's peers or contemporaries.

Representations of Known 120, Understood 110, or Ambient 130 sensations, feelings, and experiences, in a preferable embodiment of the present invention, may or may not hold a logical, direct, or indirect relationship with additional Ambient 130, Known 120, or Understood 110 sensations, feelings, and experiences. Preferably, Known 120 can become Understood 110 or Ambient 130; Understood 110 can blend or fade with Known 120 or become Ambient 130; and Ambient 130 can act as the canvas on which the Known 120 and Understood 110 are painted.

While in a preferable embodiment of the present invention, representations of Ambient 130, Known 120, and Understood 110 sensations, feelings, and experiences may or may not act as a precursor, catalyst, result, or consequence of states, transitions, experiences, or other events or qualities concurrently, simultaneously, or sequentially before, during, or after being active or inactive. A preferable embodiment of the present invention could relate the representing characterizations of Known 120, Understood 110, and Ambient 130 sensations, feelings, and experiences on a case appropriate scale ranging from likely, possible, or unlikely results of any combination of input and output data, emotion or self-concept data, or belief or preconception sets of rules.

Because of how a preferable implementation of these methods, systems, computer readable medium, and machine promote internal dialog with other states and systems within a model or available to a subject's cognition, preferable alignment or calibration of what could be preferably characterized as a dynamic Emotion Sensation Matrix could base its account from a representation of that center of subjective understanding as it relates to itself internally, its sensations of emotion, and its surrounding environment.

A preferable embodiment of the present invention could support one or more dynamic Emotion Sensation Matrix representation areas and their counterpart(s) concurrently, simultaneously, or sequentially as stand-alone units, grouped, or as parts of a whole.

A preferable embodiment of the present invention could allow for measures and increments suited toward resolution granularity appropriate for the application of these methods, systems, computer readable medium, and machine needs, capabilities, or context.

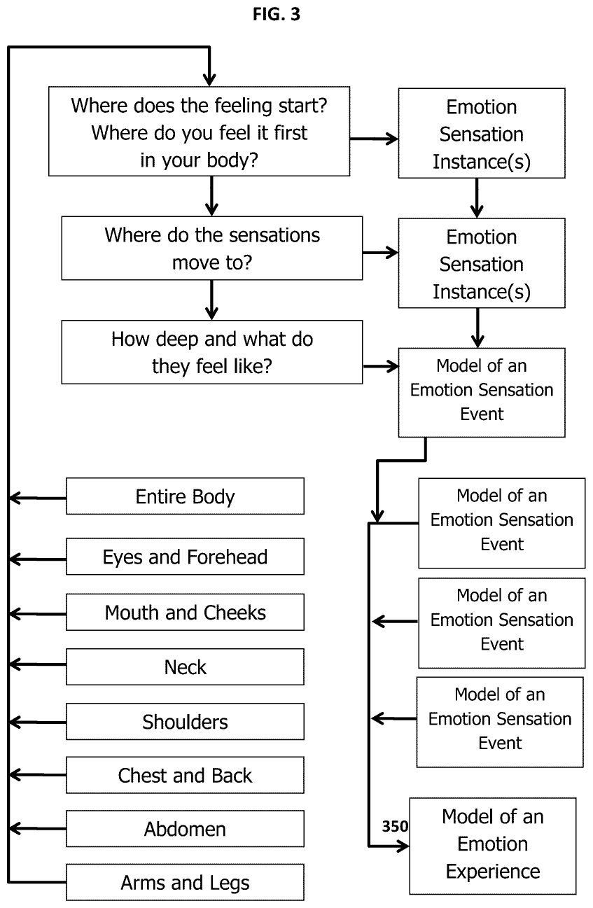

FIG. 3 is a flow chart example for defining a representation of an immersive first-person experience of emotion characterized in this example as one or more Emotion Sensation Instance(s), one or more Emotion Sensation Event(s), and one or more Emotion Sensation Experience(s) for modeling in a preferable embodiment of the present invention.

While a preferable embodiment of the present invention could, through a graphical user interface, visually model the representations of sensations a subject experiences as guided or reported from introspection, one embodiment of the present invention could also gather data for model input from devices or computing environments measuring brain activity, vital statistics, heart rate, respiration, skin temperature, skin conductance, blood oxygenation, blood volume pulse, temperature, visual or electronic indicators, or state attributes throughout the nervous system, muscular system, lymphatic system, or endocrine system. With gathered data as raw or with translation, a preferable embodiment of the present invention could define data representations of a subject's emotional state(s) for modeling, recreating, maintaining, or archive.

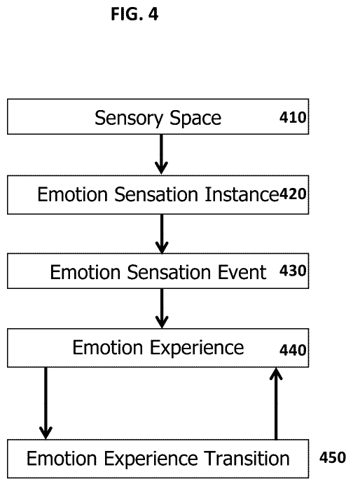

FIG. 4 illustrates an example for how representations of immersive first-person emotion experiences, in this example characterized as Emotion Experience components, relate to each other in a preferable embodiment of the present invention.

A preferable embodiment of the present invention would structure complete representations of emotion experiences first from basic building block coordinate locations in the sensory spaces 410. For the purpose of this disclosure of invention, a preferable characterization of a designated single coordinate location relating to emotion sensation in any available spaces could be an Emotion Sensation Instance 230, 250, 420, 560, 640.

Combined, in a preferable embodiment of the present invention, these Emotion Sensation Instance 230, 250 coordinate locations could be vectored, grouped, ordered, sequenced, or timed to complete what could be characterized as an Emotion Sensation Event 240, 430, 570, 650.

Preferably, it is with the combination of Emotion Sensation Instance 230, 250 coordinate locations or their associations toward acting as Emotion Sensation Event(s) 240 concurrently, simultaneously, or sequentially located throughout the sensory spaces that first define the tapestry of a greater Emotion Experience 350, 440, 580, 655 and its transitions in the framework of emotion relevant sensory space.

Once an Emotion Sensation Event 240 has been defined from component Emotion Sensation Instance(s) 230, 250, a preferable embodiment of the present invention would allow for other types of properties, settings, or attributes to be applied or edited visually, programmatically, or through the dynamic or static recalculation or manipulation of values corresponding or otherwise.

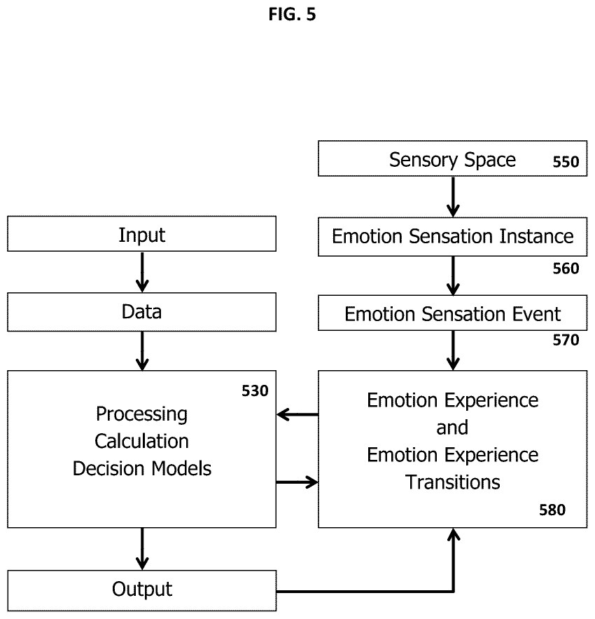

FIG. 5 is a schematic illustration of an example system architecture for incorporating representations of immersive first-person emotion experiences, in this example characterized as Emotion Experience 440, and component data with other data, calculation, or processing from application, system, or instance relevant computing environments in a preferable embodiment of the present invention

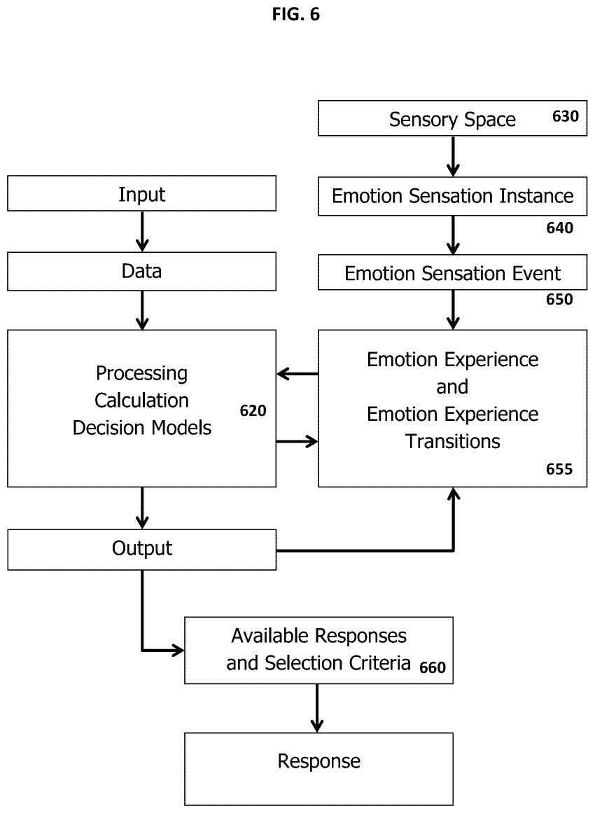

FIG. 6 is a schematic illustration of an example system architecture for incorporating representations of personality or disposition components 660 with Emotion Experience 440 processing in a preferable embodiment of the present invention.

A preferable embodiment of the present invention could implement a visual design interface for editing the location or properties of instances, events, or other representing members from internal and third person perspectives. Preferable features of a visual design interface for tasks like data entry, modeling, or editing could include paint brushes, erasers, vector or line drawings, selection, layers, and other tools similar to a graphic design or photo editing software application. Preferable parameters like direction, velocity, acceleration or decay rate, width, depth into defined sensory space(s) or distance out toward the Illusory 140, thickness, strength or intensity, temperature and texture, or the types of sensations the emotion events yield—cool breeze to needles, tension or release, a weighted feeling pulling down or an increasingly rapid rushing sensation up, the air off of a hot prairie fire blowing below your skin, or other case appropriate analogy, metaphor, or mixes relating the external to the internal and the internal experience to its meanings or symbolisms for any or Known 120, Understood 110, or Ambient 130 sensation(s) but now as location, state, property, or attribute data—could be defined to configure components of a preferable representing model for an Emotion Experience 350, 440, 580, 655.

Much like how emotion can trigger or evolve to other emotion experiences in biological models like humans or other species such as canines, a preferable embodiment of the present invention could model what could be ideally characterized as a representation of an Emotion Experience Transition 450 independently or in concert with other data, calculation, or processing from application, system, or instance relevant computing environments.

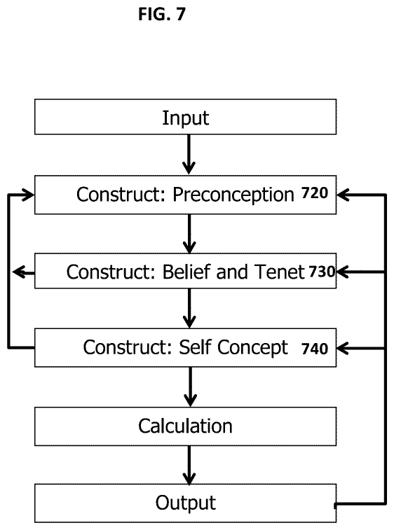

FIG. 7 is a flow chart example of how incoming data can be filtered by representations of Preconception 720, Belief 730, and Construct 740 items in one embodiment of the present invention.

A preferable embodiment of the present invention could model representing Emotion Experience Transitions 450 like the excitement of a subject moving toward an outcome and the sudden disappointment of receiving that result. Preferably, input data could filter through representations of any subject's self-concept 740, preconceptions 720, or belief 730 data constructs to dynamically guide representations of Emotion Experience Transitions 450 like anger turning to sadness or a subject's fear releasing into gratitude.

From the result of modeling representations of emotion experiences as data values throughout static or dynamic sensory spaces, a preferable embodiment of the present invention could concurrently, simultaneously, or sequentially interact with other applications, systems, devices, or instance relevant computing environments to include subjective experience or emotion data enhanced interpretation to computer environment activity like processes, data storage, calculations, decision models, or learning strategies 530, 620.

In a preferable embodiment of the present invention, implementation and integration of these systems, methods, data, calculation, or processing from application, system, or instance relevant computing environments could be performed or managed on a case by case basis with or without any or all available devices, components, or applications which perform the recited functions.

### Preferable Embodiment Examples for Data

### Data: Defined Sensory Space 210, 410, 550, 630

In a preferable embodiment of the present invention, a data model or structure could include one or more of the following to depict what could be characterized as a representation of Defined Sensory Space 210, 410, 550, 630:

Preferably, one spatial unit identifier value preferably named space_unit_id to depict the identity of a unique designated building block unit 220 of Defined Sensory Space 210. Preferably, one identifier value preferably named space_id to depict identity of any set Defined Sensory Space 210 that this unique unit of designated Defined Sensory Space 220 contributes to. Preferably, three spatial coordinate values preferably named space_coord_x, space_coord_y, and space_coord_z to depict spatial locations for this designated building block unit. Preferably, zero, one, or more property values to depict the group, order, kind, type, property, settings, or status this unit contributes with in the Defined Sensory Space 210. Preferably two date values preferably named space_date_begin and space_date_end to depict any start date or end date values for scheduling. Preferably, zero, one, or more community identifier value(s) preferably named community_space_id to depict identity of the community within an environment universe of application, system, or instance relevant computing environments that this space may contribute to. Preferably, Defined Sensory Space 210 items can be a member of or parent to other Defined Sensory Space 210 items.

### Data: Emotion Sensation Instance 230, 250, 420, 560, 640

In a preferable embodiment of the present invention, a data model or structure could include one or more of the following to depict what could be characterized as a representation of an Emotion Sensation Instance 230, 250, 420, 560, 640:

Preferably, one designated spatial unit Emotion Sensation Instance 230, 250 identifier value preferably named instance_id to depict an identity of a unique Emotion Sensation Instance 230, 250 unit. Preferably, one event identifier value preferably named event_id to depict identity of any available event that this unique instance contributes to. Preferably, three spatial coordinate values preferably named instance_coord_x, instance_coord_y, and instance_coord_z to depict spatial locations for this unit in a Defined Sensory Space 210 or out into the Illusory 250. Preferably, zero, one, or more property values to depict any vector information, group, order, kind, type, property, settings, or status this unit contributes with. Preferably, two date values preferably named instance_date_begin and instance_date_end to depict any start date or end date values for scheduling. Preferably, Emotion Sensation Instance 230, 250 items can be a member of or parent to other Emotion Sensation Instance 230, 250 items.

### Data: Emotion Sensation Event 240, 430, 570, 650

In a preferable embodiment of the present invention, a data model or structure could include one or more of the following to depict what could be characterized as a representation of an Emotion Sensation Event 240, 430, 570, 650:

Preferably, one Emotion Sensation Event 240 identifier value preferably named event_id to depict an identity of a unique Emotion Sensation Event 240 or a grouping of Emotion Sensation Instance 230, 250. Preferably, zero, one, or more property value(s) to depict any vector information, kind, type, property, settings, or status this unit or grouping(s) contributes with. Preferably, two date values preferably named event_date_begin or event_date_end to depict any start date or end date values for scheduling. Preferably, Emotion Sensation Event 240 items can be a member of or parent to other Emotion Sensation Event 240 items.

### Data: Emotion Experience 440, 580, 655

In a preferable embodiment of the present invention, a data model or structure could include one or more of the following to depict a representation of an Emotion Experience 440, 580, 655:

Preferably, one Emotion Experience identifier value preferably named experience_id to depict an identity of a unique Emotion Sensation Experience: one or more as a grouping of Emotion Sensation Event 240 or one or more unique Emotion Sensation Instance 230, 250. Preferably, zero, one, or more property value(s) to depict the group, order, kind, type, property, settings, or status this unit or grouping(s) contributes with. Preferably, two date values preferably named experience_date_begin and experience_date_end to depict any start date or end date values for scheduling. Preferably, Emotion Experience items can be a member of or parent to other Emotion Experience items.

### Data: Emotion Experience Transition 450

In a preferable embodiment of the present invention, a data model or structure could include one or more of the following to depict what could be characterized as a representation of an Emotion Experience Transition 450:

Preferably, one emotion transition identifier value preferably named transition_id to depict an identity of a unique transition between Emotion Sensation Experiences, Emotion Sensation Events 240, or unique Emotion Sensation Instance(s) 230, 250. Preferably, zero, one, or more property value(s) to depict the group, order, kind, type, property, settings, or status of this transition within the sensory space. Preferably two date values preferably named transition_date_begin and transition_date_end to depict any start date or end date values for scheduling. Preferably, Emotion Experience Transition 450 items can be a member of or parent to other Emotion Experience Transition 450 items.

### Data: Construct 720, 730, 740

In a preferable embodiment of the present invention, a data model or structure could include one or more of the following to depict what could be characterized as a representation of a Construct with data that, preferably, could hold representation to subjectively held ideas like self-concept 740, preconceptions 720, or belief 730:

Preferably, one Construct identifier value preferably named construct_id to depict an identity of a unique construct. Preferably, zero, one, or more property value(s) to depict the group, order, kind, type, property, weight, settings, or status of this Construct within the sensory space. Preferably two date values preferably named construct_date_begin and construct_date_end to depict any start date or end date values for scheduling. Preferably, Construct items can be a member of or parent to other Construct items.

Data: Community; In a preferable embodiment of the present invention, a data model or structure could include one or more of the following to depict what could be characterized as a representation of a Community. Data that, preferably, could represent groups of Defined Sensory Space 210 within an environment universe of application, system, or instance relevant computing environments:

Preferably, one Community identifier value preferably named community_id to depict an identity of a unique Community. Preferably, zero, one, or more property value(s) to depict the parent, group, order, kind, type, property, settings, or status of this Community within an environment universe of application, system, or instance relevant computing environments. Preferably two date values preferably named community_date_begin and community_date_end to depict any start date or end date values for scheduling. Preferably, Community items can be a member of or parent to other Community items.

### Preferable Embodiment Processing and Interpretation

Worlds await exploration and a history full of disclosures relevant to the areas of processing, interpreting, or incorporating modeled representations of emotion and subjective experience data prepares to be written. When interpreting or processing items in a virtual representation of subjective Emotion Experience 655 as a component to other data, calculation, or processing from application, system, or instance relevant computing environments 620, in a preferable embodiment of the present invention, it could be beneficial to use the analogy of a wall in how the Known 120, Understood 110, and Ambient 130 emotion sensations as a subject experiences them can often act as the only perceptible division between the idea of a subject's self and the external. Therefore, a preferable embodiment of the present invention could be viewed as a virtual container, a vehicle for transport, a complimentary feedback system, or a series of filters for other systems and methods relevant to data, calculation, processing or learning algorithms that may or may not occur within.

The embodiments of the invention in which an exclusive property or privilege is claimed are defined as follows:

1. A machine having a memory containing data representing either of or both data structures and program instructions for editing, storing, converting, encoding, generating, or maintaining said data structures representing
one or more immersive first-person experiences of emotion with zero, one, or more representations of immersive first-person physical sensations of self-awareness and zero, one, or more representations of a vantage
using a hierarchy of coordinate systems being generated by a method comprising the steps of:
analyzing one or more bodies;
obtaining information about a body;
generating one or more hierarchical representation.

2. The machine of claim 1, wherein
data structures representing one or more immersive first-person experiences of emotion consisting of zero, one, or more members with each member representing zero, one, or more locations or subordinate coordinate systems and having zero, one, or more relationships, references, properties, descriptions, or dimensions of interest representing a nuanced emotion experience related whole with
zero, one, or more dependently, interdependently, or independently corresponding or non-corresponding representations of immersive first-person physical sensations of self-awareness consisting of zero, one, or more members with each physical sensations related member representing zero, one, or more locations or subordinate coordinate systems and having zero, one, or more relationships, references, properties, descriptions, or dimensions of interest representing a nuanced physical sensations related whole and
zero, one, or more representations of a corresponding or non-corresponding vantage
using a hierarchy of coordinate systems being generated by a method comprising the steps recited in claim 1.

3. The machine of claim 2, wherein
hierarchy of coordinate systems is being generated by a method comprising the steps of:
analyzing one or more biological, non-biological, virtual, or theoretical body in whole, in part, or both in part and in whole;
obtaining information about each individual biological, non-biological, virtual, or theoretical body regarding one or more locations and zero, one, or more of each of the following:
relationships, references, properties, descriptions, and dimensions of interest;
generating one or more hierarchical representation with each having at least one member being represented by zero, one, or more of each of the following:
locations, relationships, references, properties, descriptions, and dimensions of interest.

4. The machine of claim 3, wherein
each data structure representing one or more immersive first-person experiences of emotion independently, interdependently, or dependently with
zero, one, or more representations of immersive first-person physical sensations of self-awareness, and
zero, one, or more representations of a vantage while either in a grouped or ungrouped state
using a hierarchy of coordinate systems being generated by a method comprising the steps recited in claim 3.

5. The machine of claim 4, wherein
one or more data structure representations having input values, output values, derivatives, outcomes, or results for representing electronically, visually, graphically, programmatically, computationally, or as data.

6. The machine of claim 5, wherein
one or more data structures representing nuanced immersive first-person subjective experiences and relevant conditions, states, components, events, properties, relationships, references, attributes, descriptions, or transitions either graphically, textually, numerically, symbolically, sequentially, or conceptually from first, second, or third person perspectives.

7. The machine of claim 6, wherein
at least one data structure having one or more representation of an immersive first-person experience of emotion and
zero, one, or more representations of immersive first-person physical sensations of self-awareness
in a grouped state and is situated in relation to
one or more representations of a corresponding vantage
using a hierarchy of coordinate systems being generated by a method comprising the steps recited in claim 6.

8. A non-transitory computer readable medium containing data representing either of or both data structures and program instructions for editing, storing, converting, encoding, generating, or maintaining said data structures representing
zero, one, or more values for subjectively held ideas including self-concept, preconception, belief, and tenet for combining with data storage, processing, calculation, or decision models and
one or more input values, output values, derivatives, outcomes, or results representing for or from
one or more immersive first-person experiences of emotion
with zero, one, or more representations of immersive first-person physical sensations of self-awareness and
zero, one, or more representations of a vantage
using a hierarchy of coordinate systems being generated by a method comprising the steps of:
analyzing one or more bodies;
obtaining information about a body;
generating one or more representation.

9. The non-transitory computer readable medium of claim 8, wherein
hierarchy of coordinate systems is being generated by a method comprising the steps of:
analyzing one or more biological, non-biological, virtual, or theoretical body in whole, in part, or both in part and in whole;
obtaining information about each individual biological, non-biological, virtual, or theoretical body regarding one or more locations and zero, one, or more of each of the following:
relationships, references, properties, descriptions, and dimensions of interest;
generating one or more hierarchical representation with each having at least one member being represented by zero, one, or more of each of the following:
locations, relationships, references, properties, descriptions, and dimensions of interest.

10. The non-transitory computer readable medium of claim 9, wherein
at least one representation of an immersive first-person experience of emotion and
zero, one, or more representations of an immersive first-person physical sensations of self-awareness
are representing in a grouped state and is situated in relation to
one or more representations of a corresponding vantage
using a hierarchy of coordinate systems being generated by a method comprising the steps recited in claim 9.

11. The non-transitory computer readable medium of claim 10, wherein
one or more data structure representation having input values, output values, derivatives, outcomes, or results for representing electronically, visually, graphically, programmatically, computationally, or as data.

12. The non-transitory computer readable medium of claim 11, wherein
each of the one or more representations of immersive first-person experiences of emotion,
each of the zero, one, or more representations of immersive first-person physical sensations of self-awareness, and
the zero, one, or more representations of a vantage
being represented from first-person, second-person, or third-person perspectives in the manner of one or more of each of the following:
graphically, programmatically, computationally, textually, numerically, symbolically, sequentially, or conceptually.

13. A system having a memory containing data representing either of or both data structures and program instructions for editing, storing, converting, encoding, generating, or maintaining said data structures wherein
one or more data structures representing
zero, one, or more values for subjectively held ideas including self-concept, preconception, belief, and tenet for combining with data storage, processing, calculation, or decision models and
one or more input values, output values, derivatives, outcomes, or results representing for or from
one or more coordinate system hierarchies using
one or more coordinate representations of immersive first-person experiences of emotion,
zero, one, or more coordinate representations of immersive first-person physical sensations of self-awareness, and
zero, one, or more coordinate representations of a vantage
using a hierarchy of coordinate systems being generated by a method comprising the steps of:
analyzing one or more bodies;
obtaining information about a body;
generating one or more hierarchical representation.

14. The system of claim 13, wherein
data structures representing
one or more immersive first-person experiences of emotion consisting of zero, one, or more members with each member representing zero, one, or more locations or subordinate coordinate systems and having zero, one, or more relationships, references, properties, descriptions, or dimensions of interest representing a nuanced emotion experience related whole with zero, one, or more dependently, interdependently, or independently corresponding or non-corresponding representations of immersive first-person physical sensations of self-awareness consisting of zero, one, or more members with each physical sensations related member representing zero, one, or more locations or subordinate coordinate systems and having zero, one, or more relationships, references, properties, descriptions, or dimensions of interest representing a nuanced physical sensations related whole and
zero, one, or more representations of a corresponding or non-corresponding vantage
using a hierarchy of coordinate systems being generated by a method comprising the steps recited in claim 13.

15. The system of claim 14, wherein
hierarchy of coordinate systems is generated by a method comprising the steps of:
analyzing one or more biological, non-biological, virtual, or theoretical body in whole, in part, or both in part and in whole;
obtaining information about each individual biological, non-biological, virtual, or theoretical body regarding one or more locations and zero, one, or more of each of the following:
relationships, references, properties, descriptions, and dimensions of interest;
generating one or more hierarchical representation with each having at least one member being represented by zero, one, or more of each of the following:
locations, relationships, references, properties, descriptions, and dimensions of interest.

16. The system of claim 15, wherein
each data structure representing
one or more immersive first-person experiences of emotion independently, interdependently, or dependently with
zero, one, or more representations of immersive first-person physical sensations of self-awareness, and
zero, one, or more representations of a vantage
while either in a grouped or ungrouped state
using a hierarchy of coordinate systems being generated by a method comprising the steps recited in claim 15.

17. The system of claim 16, wherein
one or more data structure representation having input values, output values, derivatives, outcomes, or results for representing electronically, visually, graphically, programmatically, computationally, or as data.

18. The system of claim 17, wherein
each data structure representation being graphically, textually, numerically, symbolically, sequentially, or conceptually representing
nuanced immersive first-person subjective experiences and
relevant conditions, states, components, events, properties, relationships, references, attributes, descriptions, or transitions
from first, second, or third person perspectives.

19. The system of claim 18, wherein
at least one data structure representing an immersive first-person experience of emotion and
zero, one, or more representations of immersive first-person physical sensations of self-awareness
are in a grouped state and
is situated in relation to
one or more representations of a corresponding vantage
using a hierarchy of coordinate systems being generated by a method comprising the steps recited in claim 18.

20. The system of claim 19, wherein
one or more data structures representing awareness, sentience, subjectivity, or consciousness, in part or in whole, and
zero, one, or more components of vantage
representing as Center of Consciousness, Consciousness, Cybernetic Consciousness, Artificial Consciousness, Machine Consciousness, or Synthetic Consciousness.
